(19) United States
(12) Patent Application Publication
(10) Pub. No.: US 2002/0049904 A1
(43) Pub. Date: Apr. 25, 2002

(54) Access system with possibility of learing unknown access keys

(76) Inventors: Juergen Nowottnick, Hamburg (DE); Steffen Scholze, Hamburg (DE)

Correspondence Address: U.S. Philips Corporation, 580 White Plains Road, Tarrytown, NY, 10591, US

(21) Appl. No.: 09/935,237

(22) Filed: Aug. 22, 2001

(30) Foreign Application Priority Data
Aug. 24, 2000 (DE) 10041557.1
Jan. 9, 2001 (DE) 10100576.8

(51) Int. Cl. H04L 9/00

(52) U.S. Cl. 713/169; 380/46

(57) ABSTRACT

An access system with original, authorized access keys (2) is described, wherein the access system and the original access keys (2) comprise pseudo-random generators supplying an identical, secret cryptographic key, an identical cryptographic algorithm and identical numerical sequences, which are usable for mutual authentication in a challenge-response method. For the purpose of learning one or more additional, non-original access keys (4) comprising a pseudo-random generator supplying equal numerical sequences,

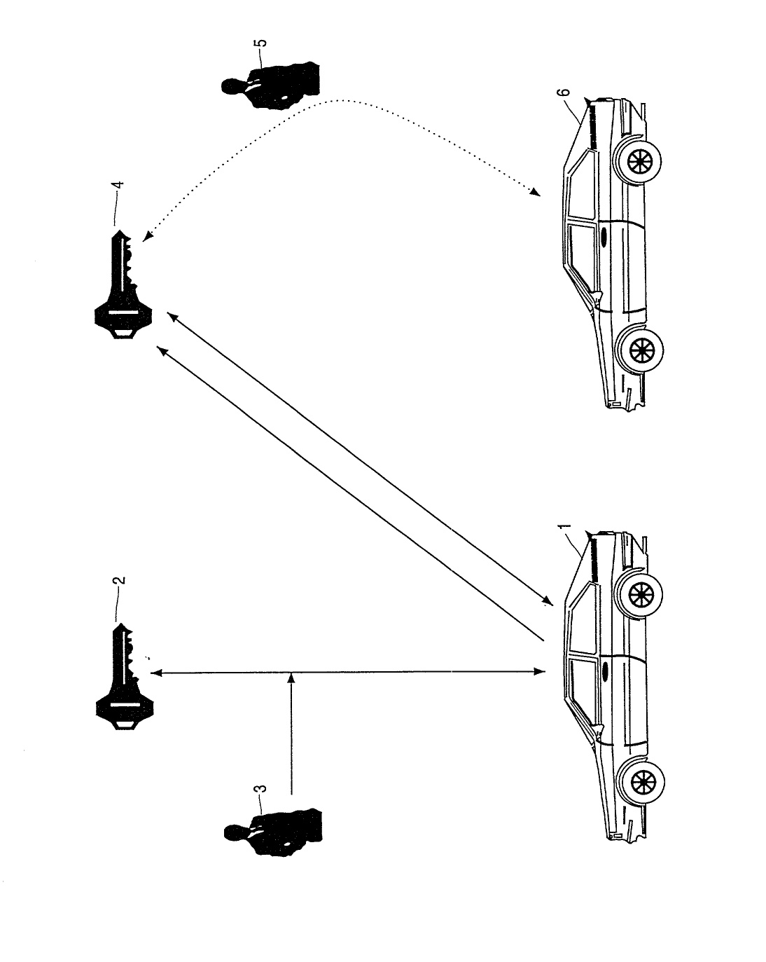

an authentication is performed at the access system (1) with an original access key (2),

the access system (1) and an additional access key (4) to be learnt are set to a learning mode,

the access key (4) to be learnt transmits its individual identifier identifying the access key (4) to the access system (1),

the access system (1) transmits the secret cryptographic key encrypted by means of a number supplied by its pseudo-random generator to the access key (4) to be learnt, which decrypts and stores this key by means of the same number supplied by its pseudo-random generator, and

the access system (1) stores the identifier of the learnt access key (4) and performs a mutual authentication with the learnt access key (4) which is subsequently usable as an access key.

The invention relates to an access system with original, authorized access keys, which system additionally allows learning of new, additional and non-original access keys so that these keys, after having been learnt, allow access to the access system, likewise as the original, authorized access keys.

In such access systems, an identical cryptographic algorithm as well as an identical, secret cryptographic key are stored both in the access system itself which may be, for example, a security system for a dwelling or a motor vehicle, and in the access keys associated with the access systems. Both are also provided with identical pseudo-random generators. A mutual authentication of the system and the access key is performed by means of a known challenge-response method. Such systems are known in the state of the art. For example, an access system for motor vehicles is known from U.S. Pat. No. 5,920,268. This access system can also be set to the learning mode in which further keys can be learnt. This is effected via a change of batteries. Further details of the learning process are not stated in this document.

It is an object of the invention to provide an access system of the type described above in which additional, new access keys can be learnt in a possibly safe and simultaneously simple manner.

According to the invention, this object is solved by the following characteristic features of claim 1.

An access system with original, authorized access keys, the access system and the original access keys comprising pseudo-random generators supplying an identical, secret cryptographic key, an identical cryptographic algorithm and identical numerical sequences, which are usable for mutual authentication in a challenge-response method, wherein, for the purpose of learning one or more additional, non-original access keys comprising a pseudorandom generator supplying equal numerical sequences,

an authentication is performed at the access system with an original access key,

the access system and an additional access key to be learnt are set to a learning mode,

the access key to be learnt transmits its individual identifier identifying the access key to the access system,

the access system transmits the secret cryptographic key encrypted by means of a number supplied by its pseudo-random generator to the access key to be learnt, which decrypts and stores this key by means of the same number supplied by its pseudo-random generator, and

the access system stores the identifier of the learnt access key and performs a mutual authentication with the learnt access key which is subsequently usable as an access key.

As already elucidated above, a mutual authentication can be performed by means of a challenge-response method in the access system between the system itself and the original, authorized access keys. Such an authentication performed in accordance with this method is generally known in the state of the art.

For learning one or more additional, non-original access keys according to the invention, a mutual authentication performed in advance is a condition. It is thereby achieved that a subsequent authentication of additional keys can only be performed in such a quasi-safe environment.

In accordance with such an authentication, the access system and a possible additional access key to be learnt are set to a learning mode. This may also be done, for example, consecutively in a sequence.

Instead of the original access key, an access key to be learnt is then used which transmits its individual identifier, which identifies it individually, to the access system.

The access system thereupon transmits the secret cryptographic key encrypted by means of a random number from the pseudo-random generator to the access key to be learnt. Since this key has a similar pseudo-random generator, the access key to be learnt is capable of canceling the encryption and can thus gain the unencrypted cryptographic key. This key is stored in the access key to be learnt.

Subsequently, a mutual authentication is performed between the access system and the learnt key. Furthermore, the access system stores the identifier of the learnt access key.

After this process, the learnt access key with its identifier is stored as the authorized access key in the access system and is thus capable of performing future authentications so that it can be used to an unlimited extent as an access key.

The access system according to the invention has the advantage that the cryptographic key is only transmitted in a quasi-safe environment. Furthermore, this key is only transmitted from the access system to a key to be learnt. This is also effected in an encrypted form only. The access key can never be transmitted from a learnt key to another access system. It is thereby achieved that this key further remains secret and cannot be “bugged”.

In this way, an authorized user of the access system having an original access key is given the possibility to allow other access keys or persons access to the access system in a flexible way and can possibly also withdraw access again by erasing the identifiers of learnt keys in the access system.

A given access key and thus a person to whom this key belongs can be authenticated for a plurality of access systems, for example, for a plurality of motor vehicles.

Although this access system comes up to the special safety requirements, for example, in dwellings or motor vehicles, it uses a small number of components and thus has a low cost for authentication of additional access keys.

An advantageous embodiment of the invention as defined in claim 2 further simplifies the method of setting an access key to be learnt to the learning mode because the access system itself transmits a corresponding command to the access key to be learnt as soon as it has been set to the learning mode, which command also sets this access key to the learning mode.

A further embodiment of the invention as defined in claim 3 allows a further increase of the system safety in that only given original access keys are authorized for learning new access keys. For example, an access key which is not authorized for learning further keys may be given to third parties without the risk of learning further keys by these third parties.

In accordance with a further embodiment of the invention as defined in claim 4, a simplification of the structure of the access system and the access keys can be obtained in that the cryptographic algorithms provided therein can be used for realizing the pseudorandom generators. In this case, given starting values are given to these cryptographic algorithms, whereupon they supply a pseudo-random sequence of numbers.

A further embodiment of the invention as defined in claim 5 allows newly learnt keys to withdraw authorization of access at any time by erasing their identifiers in the access system. It can thereby be ensured that authentication of unallowed or inadvertently learnt access keys can be withdrawn again.

The access system is particularly suitable to advantage in motor vehicles, because, despite the safety that it offers, it provides the possibility of learning additional access keys of further persons.

These and other aspects of the invention are apparent from and will be elucidated with reference to the embodiments described hereinafter.

In the drawing:

The sole FIGURE shows diagrammatically a vehicle (1) which is equipped with an access system according to the invention in a manner not shown in the FIGURE. Original, authorized access keys, for example, the original access key (2) shown diagrammatically in the FIGURE is associated with this access system.

A first user (3) is capable of accessing the access system built in the motor vehicle (1) by means of the original, authorized access key and can thus use the motor vehicle.

The user (3) of the original, authorized access key (2) is allowed access to the access system of the motor vehicle (1) in that the access key (2) is authenticated. This is done by means of a challenge-response method.

The condition is that an identical, secret cryptographic key is stored in the original access key (2) as well as in the access system in the motor vehicle (1). Furthermore, both must operate with an identical cryptographic algorithm. Moreover, both are provided with identical pseudo-random generators.

The authentication for access to the vehicle (1) is performed by means of the access key (2) in a challenge-response method operating as follows.

First, the access key (2) transmits its identifier to the access system in the motor vehicle (1). This identifier is transmitted in an unencrypted form. The access system thereupon checks the authorization of this key, i.e. it checks whether the identifier of this key is stored as the authorized access key. When this is the case, the access system transmits a random number, which it has generated by means of the pseudo random generator, to the access key (2). This random number is encrypted both in the access system and in the access key (2) by means of the cryptographic algorithm and the cryptographic key stored in both of them, so that a new number is generated from this number.

The access key (2) transmits this number gained by means of the algorithm and the key to the access system which compares this number with the number it has generated. Since both the cryptographic algorithm and the cryptographic key must be identical, this number should be equal. Only when these two numbers correspond to each other does the access system allow access to the access key (2), i.e. it authenticates this key.

For additional safety reasons, it may be necessary that the access system transmits a partial result in the computation process by means of the algorithm to the access key (2) after transmission of the random number to the access key (2). In this case, the access key (2) transmits the final result computed by means of the cryptographic algorithm and the cryptographic key back to the access system only when this partial result also occurs in the access key during the computation. An additional safety measure can thereby be realized in that a transmission of the number encrypted by means of the cryptographic algorithm and the cryptographic key in the access key to the access system only takes place when the access key is most likely assigned to the access system. Bugging of the encrypted data transmitted from the access key (2) to the access system in the vehicle (1) can thus be prevented in the unauthorized system.

Such an authentication of an original, authorized access key (2) in an access system is a condition, according to the invention, for learning additional, non-original access keys.

The FIGURE diagrammatically shows such an additional, non-original access key (4) which is to be authorized for the access system built in the vehicle (1). As elucidated above, the original access key (2) must first be authenticated in the access system. When this has been done, the user (3) can set the access system in the vehicle (1) to a learning mode. This may be effected, for example, by a given sequence of operations, such as activating blinker-clutch-blinker. The access system in the vehicle (1) set to the learning mode thereupon sets the non-original access key (4) to be learnt also to the learning mode by means of a special command.

Subsequently, the access key (4) to be learnt transmits its identifier which unambiguously identifies this access key, in an unencrypted form to the access system built in the vehicle (1).

In this quasi-safe environment which has now been obtained, the access system subsequently transmits the secret cryptographic key encrypted by means of its pseudo-random generator to the access key (4) to be learnt. The encryption may be performed, for example, in such a way that the cryptographic key and the pseudo-random number are added bit-wise.

Since an identical pseudo-random generator is built in the access key (4), the access key (4) can decrypt the encrypted, secret cryptographic key by means of the same pseudo-random number and thus gain the decrypted, cryptographic key which is stored in the access key (4).

At the end of this learning process, the access system built in the vehicle (1) stores the identifier of the learnt access key (4) so that it is one of the future identifiers which are assigned to authorized access keys. A mutual authentication between the access system and the learnt access key (4) is performed, which can be subsequently used as an access key to the access system.

In this way it is possible that, for example, a second user (5) to whom the learnt access key (4) belongs gains access to the access system of the vehicle (1) although the access key (4) is actually an original, authorized access key to a further vehicle (6). As a result, the access key (4) allows access to the access system of the vehicle (1) as well as to that of the vehicle (6).

Nevertheless, the system provides great security because additional keys can only be learnt by means of original access keys. The cryptographic key stored in the system is only transmitted in an encrypted form and cannot be read from, for example, the learnt key (4).

For additional security, only given, predetermined original authorized access keys for learning additional access keys may be used. The identifiers stored in the access system, as well as learnt access keys may also be erasable so that authorization of access may be withdrawn again from learnt access keys at a later stage.

1. An access system (1) with original, authorized access keys (2), the access system (1) and the original access keys (2) comprising pseudo-random generators supplying an identical, secret cryptographic key, an identical cryptographic algorithm and identical numerical sequences, which are usable for mutual authentication in a challenge-response method, wherein, for the purpose of learning one or more additional, non-original access keys (4) comprising a pseudo-random generator supplying equal numerical sequences,
an authentication is performed at the access system (1) with an original access key (2),
the access system (1) and an additional access key (4) to be learnt are set to a learning mode,
the access key (4) to be learnt transmits its individual identifier identifying the access key (4) to the access system (1),
the access system (1) transmits the secret cryptographic key encrypted by means of a number supplied by its pseudo-random generator to the access key (4) to be learnt, which decrypts and stores this key by means of the same number supplied by its pseudo-random generator, and
the access system (1) stores the identifier of the learnt access key (4) and performs a mutual authentication with the learnt access key (4) which is subsequently usable as an access key.

2. An access system as claimed in claim 1, characterized in that, after the access system (1) itself has been set to the learning mode, said system sets the access key (4) to be learnt to the learning mode by means of a command.

3. An access system as claimed in claim 1, characterized in that only given, predetermined access keys in the access system (1) are authorized to trigger learning of additional, non-original access keys (4).

4. An access system as claimed in claim 1, characterized in that the cryptographic algorithms provided in the access system (1) and the access keys (2, 4) are used as pseudo-random generators.

5. An access system as claimed in claim 1, characterized in that authorization of newly learnt access keys (4) in the access system (1) can be withdrawn by erasing their identifiers stored in the access system (1) are erased.

6. An access system as claimed in claim 1, characterized in that the access system (1) can be set to the learning mode by means of a predetermined sequence of operations.

7. Use of the access system as claimed in any one of claims 1 to 6 in a motor vehicle.
